(19) United States
(12) Patent Application Publication
(10) Pub. No.: US 2004/0025624 A1
(43) Pub. Date: Feb. 12, 2004

(54) Vehicle steering wheel and safety system

(75) Inventor: Martin Kreuzer, Kleinwallstadt (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/630,017

(22) Filed: Jul. 30, 2003

(30) Foreign Application Priority Data
Aug. 12, 2002 (DE) 202 12 398.7

(51) Int. Cl. B62D 1/04

(52) U.S. Cl. 74/552

(57) ABSTRACT

A vehicle steering wheel comprises a steering wheel rim, at least one tube which is filled with fluid and arranged in the steering wheel rim, and a device for generating a pressure wave in the fluid. The device is designed and the tube is arranged such that the pressure wave generates a haptic signal, able to be perceived by the driver, on a surface of the steering wheel rim.

### TECHNICAL FIELD

The invention relates to a vehicle steering wheel and a safety system for a vehicle.

There have already been discussed several devices to attract the attention of a driver of a vehicle, for example in order to indicate to him a dangerous situation or to prevent him from falling asleep. For this, acoustic, optical and haptic signals are used. Haptic signals such as, for instance, a vibration of the steering wheel rim, are particularly advantageous, because in these, in contrast to optical or acoustic signals, there is less danger that they remain unnoticed in unfavorable environmental conditions. In addition, other occupants of the vehicle are not disturbed by the signals.

DE 198 52 315 A1 suggests small, inflatable cushions arranged on the steering wheel rim which fully surround the rim, seen in a cross-sectional view. The cushion can be set with different internal pressures allowing to adapt the hardness of the rim to the dynamics of vehicle movement. Further, by inlet and outlet of fluid, signals can be generated.

The invention proposes an improvement to a warning device.

### BACKGROUND OF THE INVENTION

According to the invention, a vehicle steering wheel comprises a steering wheel rim, at least one tube which is filled with fluid and arranged in the steering wheel rim, and a device for generating a pressure wave in the fluid. The device is designed and the tube is arranged such that the pressure wave generates a haptic signal, able to be perceived by the driver, on a surface of the steering wheel rim. In this arrangement, mechanical parts for generating the haptic signal can largely be dispensed with, which makes the device less susceptible to failure. The haptic signal generated by a pressure wave in a fluid can be varied in a simple manner in intensity and form, so that it is also possible to use various kinds of signals to indicate various dangerous situations, which are able to be differentiated easily by the driver.

Contrary to DE 198 53 315 A1 which only is able to amend the hardness of the cushions, the present invention provides pressure waves to generate signals for the driver.

The haptic signal may assume the form of a pulse which is able to be perceived, but preferably the device is designed such that the pressure wave in the fluid brings about a vibration movement of the whole steering wheel or the whole steering wheel rim. According to experience, vibration movements are very distinct signals for the driver. However, alternatively the pressure wave may also be formed by a pure vibration transmission in the fluid.

Preferably, the invention is used in steering wheels in which the steering wheel rim has a leather covering, the tube being arranged directly beneath the leather covering. This guarantees that the haptic signal is conveyed to the driver's hand without appreciable losses. The tube extends along the circumference of the steering wheel rim for at least 240° thereof.

Preferably, the fluid is a liquid, and particularly preferably the liquid is glycol. However, it is also possible to use air as fluid.

In an advantageous embodiment of the invention, the device for generating a pressure wave is a pump. Small and efficient pumps exist, which can be mounted without difficulty for example in the hub region of the steering wheel or in the region of a spoke, and which are suitable to bring about pressure waves to generate a haptic signal in the fluid.

Preferably, the pump brings about a movement of a predetermined volume of fluid according to a stochastic process, whereby haptic signals can be generated which are able to be perceived in a simple manner. It is also possible to set a predetermined volume of the fluid into an oscillatory movement by the pump. In this way, a vibration of the steering wheel rim can be easily brought about in a desired frequency.

A steering wheel according to the invention can be produced with any desired number of tubes. Preferably, however, two tubes are used, which run on opposite sides of the steering wheel rim, in fact preferably on the side of the steering wheel rim facing the driver and the side facing away from the driver.

The tube or tubes advantageously run concentrically to the rotation axis of the steering wheel along the circumference of the steering wheel rim. In this way, a uniform vibration of the steering wheel rim can be achieved with low-intensity pressure waves. In addition, for example in a pulse operation, it is ensured that the driver feels the signal, irrespective of at which point he grasps the steering wheel rim.

The invention is preferably used in a safety system according to the invention, with a described steering wheel, in which in addition an electronic unit and at least one sensor connected with the electronic unit are provided, the electronic unit being designed such that in response to a signal of the sensor it actuates the device to generate a pressure wave. In this way, a haptic signal generated by a pressure wave in the fluid can be used in a variety of ways to warn a driver of dangers. Sensors can be provided which determine distances and speeds with respect to vehicles situated behind the vehicle, so that the driver can be warned on changing lanes, if he overlooks a vehicle drawing close at high speed, to mention only one example. Sensors arranged directly on the vehicle can be used, for example distance sensors; however, it is also possible to use external sensors which, for example, monitor road- or traffic conditions and convey these to an electronic unit provided in the vehicle.

### BRIEF DESCRIPTION OF THE DRAWINGS

FIG. 1 shows a diagrammatic illustration of a safety system according to the invention;

FIG. 2 shows a section along the line II-II in FIG. 1;

FIG. 3 shows a section along the line III-III in FIG. 1;

FIG. 4 shows a diagrammatic illustration of a steering wheel of the invention according to a second embodiment of the invention; and

FIG. 5 shows a section along the line V-V of FIG. 4.

### DETAILED DESCRIPTION OF THE PREFERRED EMBODIMENTS

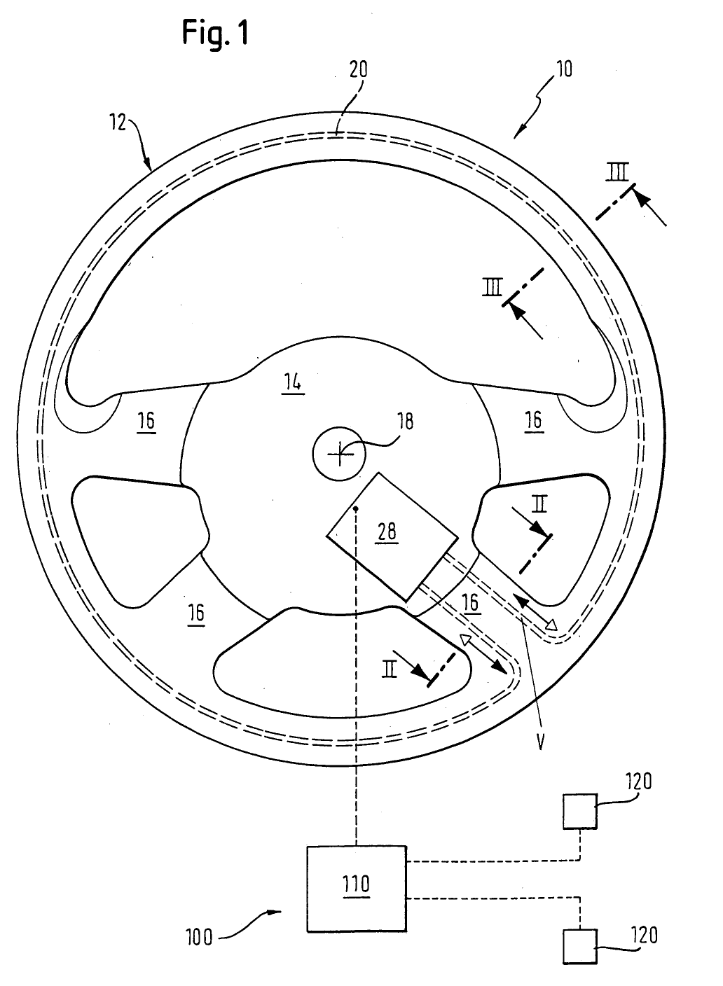

FIG. 1 shows a steering wheel 10 with a steering wheel rim 12, a hub region 14 and spokes 16 connecting steering the wheel rim 12 and the hub region 14.

Two elastic tubes 20 are arranged concentrically to the rotation axis 18 of the steering wheel 10 along the steering wheel rim 12. In each case a tube 20 runs on the upper side, i.e. on the side of the steering wheel rim 12 facing the driver, and on the rear side, i.e. on the side of the steering wheel rim 12 facing away from the driver. The tubes 20 are filled with a fluid 30, preferably glycol. As can be taken from FIG. 1 (view in the direction of the rotation axis 18), the tube extends across approximately 36° along the steering wheel rim.

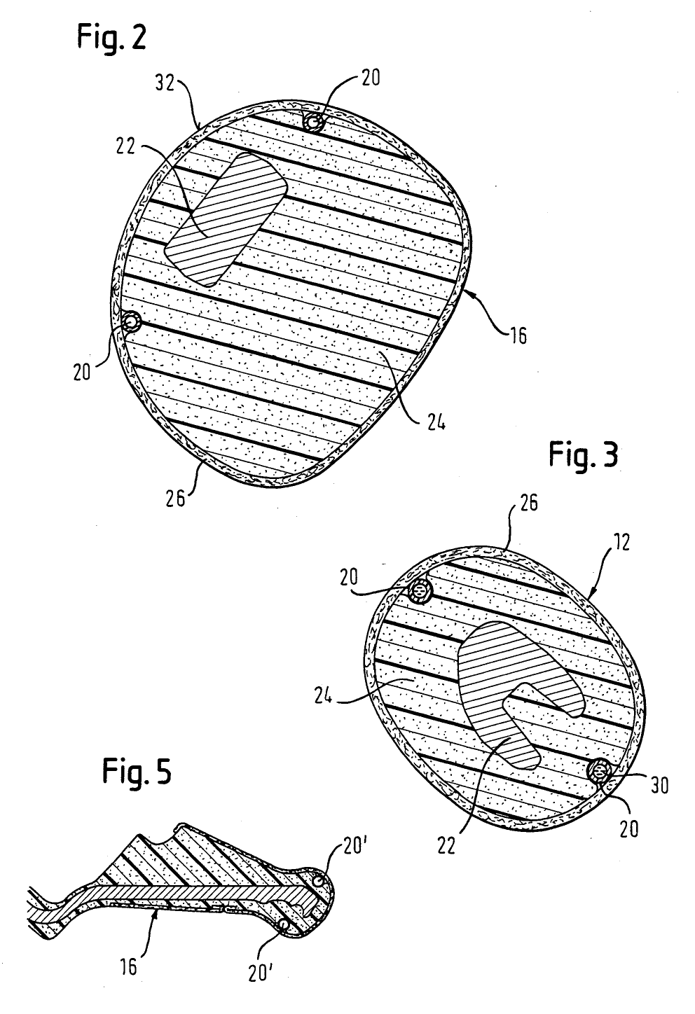

FIG. 3 shows the structure of the steering wheel rim 12 in more precise detail. The tubes 20 are arranged in recesses of a surrounding foam 24, surrounding a skeleton 22. Both the surrounding foam 24 and also the tubes 20 are surrounded by a leather covering 26, the tubes 20 lying directly beneath the leather covering 26. FIGS. 2, 3 and 5 show the embedding of the tubes 20, 20′ in the steering wheel rim. The steering wheel rim is not surrounded by the tube(s), as seen in cross-section. The tubes have a maximum diameter of 6 mm. Thus, the tube covers only a very small portion of the circumference of the steering wheel rim, with respect to a cross sectional view of the steering wheel rim.

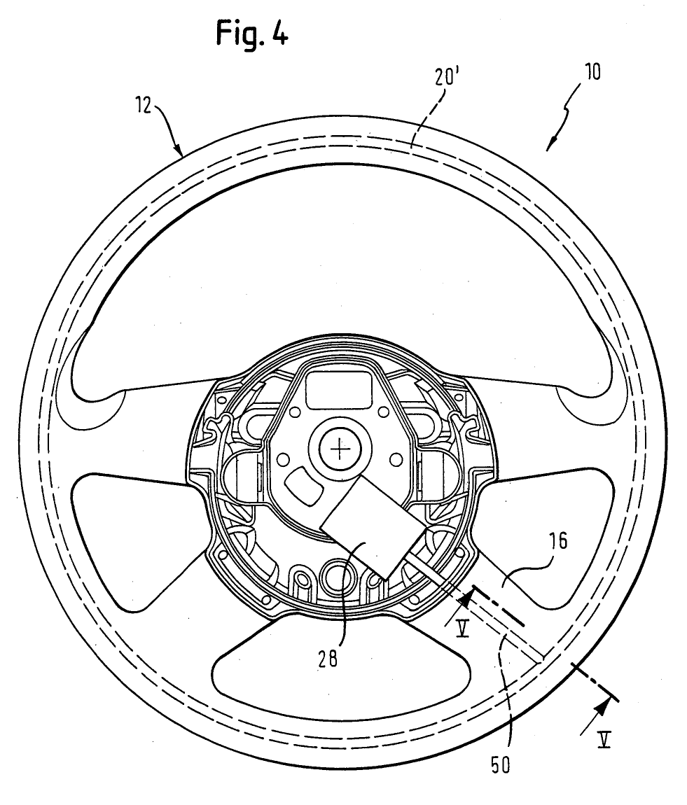

Sections of the tubes 20 extend along one of the spokes 16 up to a pump 28, which is arranged in the hub region 14 of the steering wheel 10 (FIGS. 1, 4). The pump 28 serves as a device to generate a pressure wave in the fluid 30. For this, the pump 28 preferably moves a predetermined volume V of the fluid 30, which leads to a widening of the flexible tubes 20, which continues in a wave form and represents a haptic signal which is perceived by the driver. The movement of the volume V can be oscillating. In addition, however, it would also be possible to initiate the movement of the volume (volume stroke) according to a stochastic process.

As a result of the movement of the volume V, in addition the steering wheel rim 12 can be set at least minimally into vibrations, preferably with predetermined differing frequencies. The pressure waves are able to be perceived by a driver as haptic signals on the surface 32 of the steering wheel rim 12. The vibration of the entire steering wheel rim 12 is likewise perceived as a haptic signal by a driver.

The steering wheel 10 is part of a safety system 100 (FIG. 1), which contains an electronic unit 110 and sensors 120, which are connected with the electronic unit 110.

The electronic unit 110 is in addition able to transmit signals to the pump 28 and to thus cause it to generate pressure waves in the fluid 30. The sensors 120 can be arranged in a vehicle interior, but may also be constructed as external sensors.

FIGS. 4 and 5 show a slightly modified second embodiment of a steering wheel 10. In contrast to the previously described first embodiment, the flexible expandable tubes 20′, running along the steering wheel rim 12, have a closed, ring-shaped configuration, i.e. extend along the full 360° of the steering wheel rim. With the pump 28, the tubes 20′ are connected along one of the spokes 16 by means of connecting tubes 50. Also in this case the pump 28, via the connecting tubes 50, directs a pressure wave into the tubes 20′, which is perceived by a driver as a haptic signal on the surface 32 of the steering wheel rim 12, by the ring-shaped widening of the tube 20, generated by the volume movement of the fluid, running around like a wave along the steering wheel rim 12, which likewise represents a haptic signal that is perceived by the driver.

The number of tubes and their connection to the pump can be adapted by a specialist in the art to the respective requirements.

It is also conceivable to replace the pump 28 by a different device which is suitable for bringing about a pressure wave in the fluid 30.

Due to the pressure wave in the fluid 30, the steering wheel rim as a whole can at least partially be made to oscillate.

1. A vehicle steering wheel comprising a steering wheel rim,
at least one tube which is filled with a fluid and arranged in said steering wheel rim,
and a device for generating a pressure wave in said fluid,
said device being designed and said tube being arranged such that said pressure wave generates a haptic signal, able to be perceived by a driver, on a surface of said steering wheel rim.

2. The vehicle steering wheel according to claim 1, wherein said steering wheel rim has a leather covering and said tube is arranged directly beneath said leather covering.

3. The vehicle steering wheel according to claim 1, wherein said tube runs concentrically to a rotation axis of said steering wheel along said steering wheel rim.

4. The vehicle steering wheel according to claim 1, wherein said fluid is a liquid.

5. The vehicle steering wheel according to claim 4, wherein said liquid is glycol.

6. The vehicle steering wheel according to claim 1, wherein said fluid is air.

7. The vehicle steering wheel according to claim 1, wherein said device is a pump.

8. The vehicle steering wheel according to claim 7, wherein said pump is arranged in a region of a hub of said steering wheel.

9. The vehicle steering wheel according to claim 7, wherein said pump sets a predetermined volume of said fluid into an oscillating movement.

10. The vehicle steering wheel according to claim 7, wherein said pump moves a predetermined volume of said fluid according to a stochastic process.

11. The vehicle steering wheel according to claim 1, wherein said device is designed such that said pressure wave in said fluid brings about a vibration movement of said steering wheel rim.

12. The vehicle steering wheel according to claim 1, wherein said tube extends over at least 240° along the circumference of said steering wheel rim seen in a direction of said steering wheel's rotational axis.

13. The vehicle steering wheel according to claim 1, wherein said device generates a pressure wave running along the circumference of said steering wheel rim, seen in a direction of said steering wheel's rotational axis.

14. A safety system including a vehicle steering wheel according to claim 1, said safety system comprising an electronic unit and at least one sensor connected with said electronic unit, said electronic unit being designed such that in response to a signal of said sensor it actuates said device for generating a pressure wave.
